(19) United States
(12) Patent Application Publication
(10) Pub. No.: US 2016/0360200 A1
(43) Pub. Date: Dec. 8, 2016

(54) VIDEO ENCODING METHOD, VIDEO DECODING METHOD, VIDEO ENCODING APPARATUS, VIDEO DECODING APPARATUS, VIDEO ENCODING PROGRAM, AND VIDEO DECODING PROGRAM

(71) Applicant: NIPPON TELEGRAPH AND TELEPHONE CORPORATION, Tokyo (JP)

(72) Inventors: Shinya SHIMIZU, Yokosuka-shi (JP); Shiori SUGIMOTO, Yokosuka-shi (JP); Akira KOJIMA, Yokosuka-shi (JP)

(73) Assignee: NIPPON TELEGRAPH AND TELEPHONE CORPORATION, Tokyo (JP)

(21) Appl. No.: 15/105,355

(22) PCT Filed: Dec. 22, 2014
(86) PCT No.: PCT/JP2014/083897

§ 371 Date: Jun. 16, 2016

(30) Foreign Application Priority Data
Dec. 27, 2013 (JP) 2013-273317

(51) Int. Cl. H04N 19/119; H04N 19/182; H04N 19/136; H04N 19/176; H04N 19/597

(52) U.S. Cl. CPC H04N 19/119; H04N 19/176; H04N 19/597; H04N 19/136; H04N 19/182

(57) ABSTRACT

A video encoding apparatus is a video encoding method apparatus which, when encoding an encoding target picture which is one frame of a multi-view video including videos of a plurality of different views, performs predictive encoding from a reference view different from a view of the encoding target picture, for each encoding target area which is one of areas into which the encoding target picture is divided, using a depth map for an object in the multi-view video, and includes an area division setting step unit which determines a division method of the encoding target area based on a positional relationship between the view of the encoding target picture and the reference view, and a disparity vector setting step unit which sets a disparity vector for the reference view using the depth map, for each of sub-areas obtained by dividing the encoding target area in accordance with the division method.

### TECHNICAL FIELD

The present invention relates to a video encoding method, a video decoding method, a video encoding apparatus, a video decoding apparatus, a video encoding program, and a video decoding program.

Priority is claimed on Japanese Patent Application No. 2013-273317, filed Dec. 27, 2013, the content of which is incorporated herein by reference.

### BACKGROUND ART

A free viewpoint video is a video in which a user can freely designate a position and a direction (hereinafter referred to as “view”) of a camera within a photographing space. In the free viewpoint video, the user arbitrarily designates the view, and thus videos from all views likely to be designated cannot be retained. Therefore, the free viewpoint video is configured with an information group necessary to generate videos from some views that can be designated. It is to be noted that the free viewpoint video is also called a free viewpoint television, an arbitrary viewpoint video, an arbitrary viewpoint television, or the like.

The free viewpoint video is expressed using a variety of data formats, but there is a scheme using a video and a depth map (distance picture) corresponding to a frame of the video as the most general format (see, for example, Non-Patent Document 1). The depth map expresses, for each pixel, a depth (distance) from a camera to an object. The depth map expresses a three-dimensional position of the object.

If a depth satisfies a certain condition, the depth is inversely proportional to a disparity between two cameras (a pair of cameras). Therefore, the depth is also called a disparity map (disparity picture). In the field of computer graphics, the depth becomes information stored in a Z buffer, and thus the depth may also be called a Z picture or a Z map. It is to be noted that instead of the distance from the camera to the object, a coordinate value (Z value) of a Z axis of a three-dimensional coordinate system extended on a space to be expressed may be used as the depth.

If an X-axis is determined as a horizontal direction and a Y-axis is determined as a vertical direction for a captured picture, the Z-axis matches the direction of the camera. However, if a common coordinate system is used for a plurality of cameras, the Z axis may not match the direction of the camera. Hereinafter, the distance and the Z value are referred to as a “depth” without being distinguished. Further, a picture in which the depth is expressed as a pixel value is referred to as a “depth map”. However, strictly speaking, it is necessary for a pair of cameras which becomes a reference to be set for the disparity map.

When the depth is expressed as a pixel value, there is a method using a value corresponding to a physical quantity as the pixel value as is, a method using a value obtained through quantization of the depth when values between a minimum value and a maximum value are quantized in a predetermined number of sections, and a method using a value obtained by quantizing the difference from a minimum value of the depth in a predetermined step size. If a range to be expressed is limited, the depth can be expressed with higher accuracy when additional information such as a minimum value is used.

Further, methods for quantizing the physical quantity at equal intervals include a method for quantizing the physical quantity as is, and a method for quantizing the reciprocal of the physical quantity. The reciprocal of a distance becomes a value proportional to a disparity. Accordingly, if it is necessary for the distance to be expressed with high accuracy, the former is often used, and if it is necessary for the disparity to be expressed with high accuracy, the latter is often used.

Hereinafter, a picture in which the depth is expressed is referred to as a “depth map” regardless of the method for expressing the depth as a pixel value and a method for quantizing the depth. Since the depth map is expressed as a picture having one value for each pixel, the depth map can be regarded as a grayscale picture. An object is continuously present in a real space and cannot instantaneously move to a distant position. Therefore, the depth map is said to have a spatial correlation and a temporal correlation, similar to a video signal.

Accordingly, it is possible to effectively code the depth map or a video including continuous depth maps while removing spatial redundancy and temporal redundancy by using a picture coding scheme used to code a picture signal or a video coding scheme used to code a video signal. Hereinafter, the depth map and the video including continuous depth maps are referred to as a “depth map” without being distinguished.

General video coding will be described. In video coding, each frame of the video is divided into processing unit blocks called macroblocks in order to achieve efficient coding using characteristics that an object is continuous spatially and temporally. In video coding, for each macroblock, a video signal is predicted spatially and temporally, and prediction information indicating a method for prediction and a prediction residual are coded.

When the video signal is spatially predicted, information indicating a direction of spatial prediction, for example, becomes the prediction information. When the video signal is temporally predicted, information indicating a frame to be referred to and information indicating a position within the frame, for example, become the prediction information. Since the spatially performed prediction is prediction within the frame, the spatially performed prediction is called intra-frame prediction, intra-picture prediction, or intra prediction.

Since the temporally performed prediction is prediction between frames, the temporally performed prediction is called inter-frame prediction, inter-picture prediction, or inter prediction. Further, the temporally performed prediction is also referred to as motion-compensated prediction because a temporal change in the video, that is, motion is compensated for to predict the video signal.

When a multi-view video including videos obtained by photographing the same scene from a plurality of positions and/or directions is coded, disparity-compensated prediction is used because a change between views in the video, that is, a disparity is compensated for to predict the video signal.

In coding of a free viewpoint video configured with videos based on a plurality of views and depth maps, since both of the videos based on the plurality of views and the depth maps have a spatial correlation and a temporal correlation, an amount of data can be reduced by coding each of the videos based on the plurality of views and the depth maps using a typical video coding scheme. For example, when a multi-view video and depth maps corresponding to the multi-view video are expressed using MPEG-C Part. 3, each of the multi-view video and the depth maps is coded using an existing video coding scheme.

Further, there is a method for achieving efficient coding using a correlation present between views by using disparity information obtained from a depth map when videos based on the plurality of views and depth maps are coded together. For example, Non-Patent Document 2 describes a method for achieving efficient coding by obtaining a disparity vector from a depth map for a processing target area, determining a corresponding area on a previously coded video in another view using the disparity vector, and using a video signal in the corresponding area as a prediction value of a video signal in the processing target area. As another example, Non-Patent Document 3 achieves efficient coding by using motion information used when the obtained corresponding area is coded as motion information of the processing target area or a prediction value thereof.

In this case, in order to achieve efficient coding, it is necessary to acquire a high-precision disparity vector for each processing target area. In the methods described in Non-Patent Document 2 and Non-Patent Documents 3, a correct disparity vector can be acquired, even when different objects are photographed in the processing target area, by obtaining a disparity vector for each of sub-areas into which the processing target area is divided.

### PRIOR ART DOCUMENTS

### Non-Patent Documents

Non-Patent Document 1: Y. Mori, N. Fukusima, T. Fujii, and M. Tanimoto, “View Generation with 3D Warping Using Depth Information for FTV”, In Proceedings of 3DTV-CON2008, pp. 229-232, May 2008.

Non-Patent Document 2: G Tech, K. Wegner, Y. Chen, and S. Yea, “3D-HEVC Draft Text 1”, JCT-3V Doc., JCT3V-E1001 (version 3), September 2013.

Non-Patent Document 3: S. Shimizu and S. Sugimoto, “CE1-related: View Synthesis Prediction via Motion Field Synthesis”, JCT-3V Doc., JCT3V-F0177, October 2013.

### SUMMARY OF INVENTION

### Problems to be solved by the Invention

In the methods described in Non-Patent Document 2 and Non-Patent Document 3, highly efficient predictive coding can be achieved by converting the value of the depth map and acquiring a highly accurate disparity vector for each small area. However, the depth map only expresses a three-dimensional position of an object photographed in each area and a disparity vector, and does not guarantee that the same object is photographed between views. Therefore, in the methods described in Non-Patent Document 2 and Non-Patent Document 3, if an occlusion occurs between the views, a correct correspondence relationship of the object between the views cannot be obtained. It is to be noted that the occlusion refers to a state in which an object present in the processing target area is occluded by another object and cannot be seen from a predetermined view.

In view of the above circumstance, an object of the present invention is to provide a video encoding method, a video decoding method, a video encoding apparatus, a video decoding apparatus, a video encoding program, and a video decoding program capable of improving the accuracy of inter-view prediction of a video signal and a motion vector and improving the efficiency of video coding by obtaining a correspondence relationship in consideration of an occlusion between views from a depth map in coding of free viewpoint video data having videos for a plurality of views and depth maps as components.

### Means for Solving the Problems

An aspect of the present invention is a video encoding apparatus which, when encoding an encoding target picture which is one frame of a multi-view video including videos of a plurality of different views, performs predictive encoding from a reference view different from a view of the encoding target picture, for each encoding target area which is one of areas into which the encoding target picture is divided, using a depth map for an object in the multi-view video, and the video encoding apparatus includes: an area division setting unit which determines a division method of the encoding target area based on a positional relationship between the view of the encoding target picture and the reference view; and a disparity vector setting unit which sets a disparity vector for the reference view using the depth map, for each of sub-areas obtained by dividing the encoding target area in accordance with the division method.

Preferably, the aspect of the present invention further includes a representative depth setting unit which sets a representative depth from the depth map for each of the sub-areas, and the disparity vector setting unit sets the disparity vector based the representative depth set for each of the sub-areas.

Preferably, in the aspect of the present invention, the area division setting unit sets a direction of a division line for dividing the encoding target area to the same direction as the direction of a disparity generated between the view of the encoding target picture and the reference view.

An aspect of the present invention is a video encoding apparatus which, when encoding an encoding target picture which is one frame of a multi-view video including videos of a plurality of different views, performs predictive encoding from a reference view different from a view of the encoding target picture, for each encoding target area which is one of areas into which the encoding target picture is divided, using a depth map for an object in the multi-view video, and the video encoding apparatus includes: an area division unit which divides the encoding target area into a plurality of sub-areas; a processing direction setting unit which sets a processing order of the sub-areas based on a positional relationship between the view of the encoding target picture and the reference view; and a disparity vector setting unit which sets a disparity vector for the reference view using the depth map for each of the sub-areas in accordance with the order while determining an occlusion with a sub-area processed prior to each of the sub-areas.

Preferably, in the aspect of the present invention, the processing direction setting unit sets the order in the same direction as the direction of the disparity generated between the view of the encoding target picture and the reference view for each set of the sub-areas present in the same direction as the direction of the disparity.

Preferably, in the aspect of the present invention, the disparity vector setting unit compares a disparity vector for the sub-area processed prior to each of the sub-areas with a disparity vector set for each of the sub-areas using the depth map and sets a disparity vector having a larger size as the disparity vector for the reference view.

Preferably, the aspect of the present invention further includes a representative depth setting unit which sets a representative depth from the depth map for each of the sub-areas, and the disparity vector setting unit compares the representative depth for the sub-area processed prior to each of the sub-areas with the representative depth set for each of the sub-areas, and sets the disparity vector based on the representative depth which indicates being closer to the view of the encoding target picture.

An aspect of the present invention is a video decoding apparatus which, when decoding a decoding target picture from encoded data of a multi-view video including videos of a plurality of different views, performs decoding while performing prediction from a reference view different from a view of the decoding target picture, for each decoding target area which is one of areas into which the decoding target picture is divided, using a depth map for an object in the multi-view video, and the video decoding apparatus includes: an area division setting unit which determines a division method of the decoding target area based on a positional relationship between the view of the decoding target picture and the reference view; and a disparity vector setting unit which sets a disparity vector for the reference view using the depth map, for each of sub-areas obtained by dividing the decoding target area in accordance with the division method.

Preferably, the aspect of the present invention further includes a representative depth setting unit which sets a representative depth from the depth map for each of the sub-areas, and the disparity vector setting unit sets the disparity vector based the representative depth set for each of the sub-areas.

Preferably, in the aspect of the present invention, the area division setting unit sets a direction of a division line for dividing the decoding target area to the same direction as the direction of a disparity generated between the view of the decoding target picture and the reference view.

An aspect of the present invention is a video decoding apparatus which, when decoding a decoding target picture from encoded data of a multi-view video including videos of a plurality of different views, performs decoding while performing prediction from a reference view different from a view of the decoding target picture, for each decoding target area which is one of areas into which the decoding target picture is divided, using a depth map for an object in the multi-view video, and the video decoding apparatus includes: an area division unit which divides the decoding target area into a plurality of sub-areas; a processing direction setting unit which sets a processing order of the sub-areas based on a positional relationship between the view of the decoding target picture and the reference view; and a disparity vector setting unit which sets a disparity vector for the reference view using the depth map for each of the sub-areas in accordance with the order while determining an occlusion with a sub-area processed prior to each of the sub-areas.

Preferably, in the aspect of the present invention, the processing direction setting unit sets the order in the same direction as the direction of the disparity generated between the view of the decoding target picture and the reference view for each set of the sub-areas present in the same direction as the direction of the disparity.

Preferably, in the aspect of the present invention, the disparity vector setting unit compares a disparity vector for the sub-area processed prior to each of the sub-areas with the disparity vector set using the depth map for each of the sub-areas and sets a disparity vector having a larger size as the disparity vector for the reference view.

Preferably, the aspect of the present invention further includes a representative depth setting unit which sets a representative depth from the depth map for each of the sub-areas, and the disparity vector setting unit compares the representative depth for the sub-area processed prior to each of the sub-areas with the representative depth set for each of the sub-areas, and sets the disparity vector based on the representative depth which indicates being closer to the view of the decoding target picture.

An aspect of the present invention is a video encoding method for, when encoding an encoding target picture which is one frame of a multi-view video including videos of a plurality of different views, performing predictive encoding from a reference view different from a view of the encoding target picture, for each encoding target area which is one of areas into which the encoding target picture is divided, using a depth map for an object in the multi-view video, and the video encoding method includes: an area division setting step of determining a division method of the encoding target area based on a positional relationship between the view of the encoding target picture and the reference view; and a disparity vector setting step of setting a disparity vector for the reference view using the depth map, for each of sub-areas obtained by dividing the encoding target area in accordance with the division method.

An aspect of the present invention a video encoding method for, when encoding an encoding target picture which is one frame of a multi-view video including videos of a plurality of different views, performing predictive encoding from a reference view different from a view of the encoding target picture, for each encoding target area which is one of areas into which the encoding target picture is divided, using a depth map for an object in the multi-view video, and the video encoding method includes: an area division step of dividing the encoding target area into a plurality of sub-areas; a processing direction setting step of setting a processing order of the sub-areas based on a positional relationship between the view of the encoding target picture and the reference view; and a disparity vector setting step of setting a disparity vector for the reference view using the depth map for each of the sub-areas in accordance with the order while determining an occlusion with a sub-area processed prior to each of the sub-areas.

An aspect of the present invention is a video decoding method for, when decoding a decoding target picture from encoded data of a multi-view video including videos of a plurality of different views, performing decoding while performing prediction from a reference view different from a view of the decoding target picture, for each decoding target area which is one of areas into which the decoding target picture is divided, using a depth map for an object in the multi-view video, and the video decoding method includes: an area division setting step of determining a division method of the decoding target area based on a positional relationship between the view of the decoding target picture and the reference view; and a disparity vector setting step of setting a disparity vector for the reference view using the depth map, for each of sub-areas obtained by dividing the decoding target area in accordance with the division method.

An aspect of the present invention a video decoding method for, when decoding a decoding target picture from encoded data of a multi-view video including videos of a plurality of different views, performing decoding while performing prediction from a reference view different from a view of the decoding target picture, for each decoding target area which is one of areas into which the decoding target picture is divided, using a depth map for an object in the multi-view video, and the video decoding method includes: an area division step of dividing the decoding target area into a plurality of sub-areas; a processing direction setting step of setting a processing order of the sub-areas based on a positional relationship between the view of the decoding target picture and the reference view; and a disparity vector setting step of setting a disparity vector for the reference view using the depth map for each of the sub-areas in accordance with the order while determining an occlusion with a sub-area processed prior to each of the sub-areas.

An aspect of the present invention is a video encoding program for causing a computer to execute the video encoding method.

An aspect of the present invention is a video decoding program for causing a computer to execute the video decoding method.

### Advantageous Effects of Invention

According to the present invention, it is possible to improve the accuracy of inter-view prediction of a video signal and a motion vector and improve the efficiency of video coding by obtaining a correspondence relationship between views in consideration of an occlusion from the depth map in coding of free viewpoint video data having videos for a plurality of views and depth maps as components.

### BRIEF DESCRIPTION OF DRAWINGS

FIG. 1 is a block diagram illustrating a configuration of a video encoding apparatus in an embodiment of the present invention.

FIG. 2 is a flowchart illustrating an operation of the video encoding apparatus in an embodiment of the present invention.

FIG. 3 is a flowchart illustrating a first example of a process (step S104) in which a disparity vector field generation unit generates a disparity vector field in an embodiment of the present invention.

FIG. 4 is a flowchart illustrating a second example of the process (step S104) in which the disparity vector field generation unit generates the disparity vector field in an embodiment of the present invention.

FIG. 5 is a block diagram illustrating a configuration of a video decoding apparatus in an embodiment of the present invention.

FIG. 6 is a flowchart illustrating an operation of the video decoding apparatus in an embodiment of the present invention.

FIG. 7 is a block diagram illustrating an example of a hardware configuration when the video encoding apparatus in an embodiment of the present invention is configured with a computer and a software program.

FIG. 8 is a block diagram illustrating an example of a hardware configuration when the video decoding apparatus in an embodiment of the present invention is configured with a computer and a software program.

### MODES FOR CARRYING OUT THE INVENTION

Hereinafter, a video encoding method, a video decoding method, a video encoding apparatus, a video decoding apparatus, a video encoding program, and a video decoding program of an embodiment of the present invention will be described in detail with reference to the accompanying drawings.

In the following description, a multi-view video captured by two cameras (camera A and camera B) is assumed to be encoded. A view from camera A is assumed to be a reference view. Moreover, a video captured by camera B is encoded and decoded frame by frame.

It is to be noted that information necessary for obtaining a disparity from a depth is assumed to be given separately. Specifically, this information is extrinsic parameters expressing a positional relationship between camera A and camera B, intrinsic parameters expressing information on projection onto a picture plane by a camera, or the like. Necessary information may also be given in a different format as long as the information has the same meaning as the above. A detailed description of the camera parameters is given in, for example, a document, Olivier Faugeras, “Three-Dimensional Computer Vision”, pp. 33-66, MIT Press; BCTC/UFF-006.37 F259 1993, ISBN: 0-262-06158-9. In this document, parameters indicating a positional relationship between a plurality of cameras and parameters expressing information on projection onto a picture plane by a camera are described.

In the following description, by adding information capable of specifying a position (for example, a coordinate value, or an index that can be associated with the coordinate value) to a picture, a video frame (picture frame), or a depth map, information to which the information capable of specifying the position is added is assumed to indicate a video signal sampled in a pixel in the position, or a depth based thereon. Further, a value obtained by adding a vector to the index value that can be associated with the coordinate value is assumed to indicate a coordinate value at a position obtained by shifting the coordinate by the vector. Further, a value obtained by adding a vector to an index value that can be associated with a block is assumed to indicate a block at a position obtained by shifting the block by the vector.

First, encoding will be described.

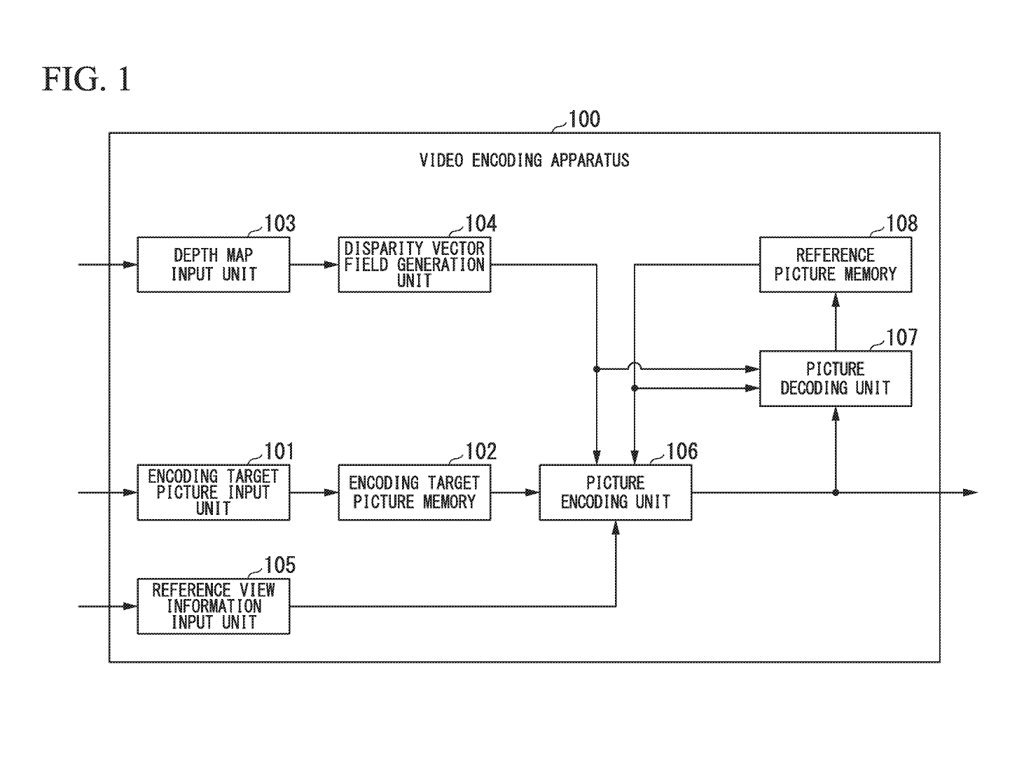

FIG. 1 is a block diagram illustrating a configuration of a video encoding apparatus in an embodiment of the present invention. The video encoding apparatus 100 includes an encoding target picture input unit 101, an encoding target picture memory 102, a depth map input unit 103, a disparity vector field generation unit 104 (a disparity vector setting unit, a processing direction setting unit, a representative depth setting unit, an area division setting unit, and an area division unit), a reference view information input unit 105, a picture encoding unit 106, a picture decoding unit 107, and a reference picture memory 108.

The encoding target picture input unit 101 inputs a video which is an encoding target to the encoding target picture memory 102 for each frame. Hereinafter, the video which is an encoding target is referred to as an “encoding target picture group”. A frame to be input and encoded is referred to as an “encoding target picture”. The encoding target picture input unit 101 inputs the encoding target picture for each frame from the encoding target picture group captured by camera B. Hereinafter, a view (camera B) from which the encoding target picture is captured is referred to as an “encoding target view”. The encoding target picture memory 102 stores the input encoding target picture.

The depth map input unit 103 inputs a depth map which is referred to when a disparity vector is obtained based on a correspondence relationship of pixels between views, to the disparity vector field generation unit 104. Here, although the depth map corresponding to the encoding target picture is assumed to be input, a depth map based on another view may be input.

It is to be noted that a depth map expresses a three-dimensional position of an object included in the encoding target picture for each pixel. The depth map may be expressed using, for example, the distance from a camera to the object, a coordinate value of an axis which is not parallel to the picture plane, or an amount of disparity with respect to another camera (for example, camera A). Here, although the depth map is assumed to be passed in the form of a picture, the depth map may not be passed in the form of a picture as long as the same information can be obtained.

Hereinafter, a view of a picture to be referred to when the encoding target picture is encoded is referred to as a “reference view”. Further, a picture from the reference view is referred to as a “reference view picture”.

The disparity vector field generation unit 104 generates, from the depth map, a disparity vector field indicating an area included in the encoding target picture and an area based on the reference view associated with the included area.

The reference view information input unit 105 inputs information based on a video captured from a view (camera A) different from that of the encoding target picture, that is, information based on the reference view picture (hereinafter referred to as “reference view information”) to the picture encoding unit 106. The video captured from the view (camera A) different from that of the encoding target picture is a picture that is referred to when the encoding target picture is encoded. That is, the reference view information input unit 105 inputs information based on a target predicted when the encoding target picture is encoded, to the picture encoding unit 106.

It is to be noted that the reference view information is a reference view picture, a vector field based on the reference view picture, or the like. This vector is, for example, a motion vector. If the reference view picture is used, the disparity vector field is used for disparity-compensated prediction. If the vector field based on the reference view picture is used, the disparity vector field is used for inter-view vector prediction. It is to be noted that other information (for example, a block division method, a prediction mode, an intra prediction direction, or an in-loop filter parameter) may also be used for the prediction. Further, a plurality of pieces of information may be used for the prediction.

The picture encoding unit 106 predictively encodes the encoding target picture based on the generated disparity vector field, a decoding target picture stored in the reference picture memory 108, and the reference view information.

The picture decoding unit 107 generates a decoding target picture by decoding a newly input encoding target picture based on the decoding target picture (reference view picture) stored in the reference picture memory 108 and the disparity vector field generated by the disparity vector field generation unit 104.

The reference picture memory 108 stores the decoding target picture decoded by the picture decoding unit 107.

Next, an operation of the video encoding apparatus 100 will be described.

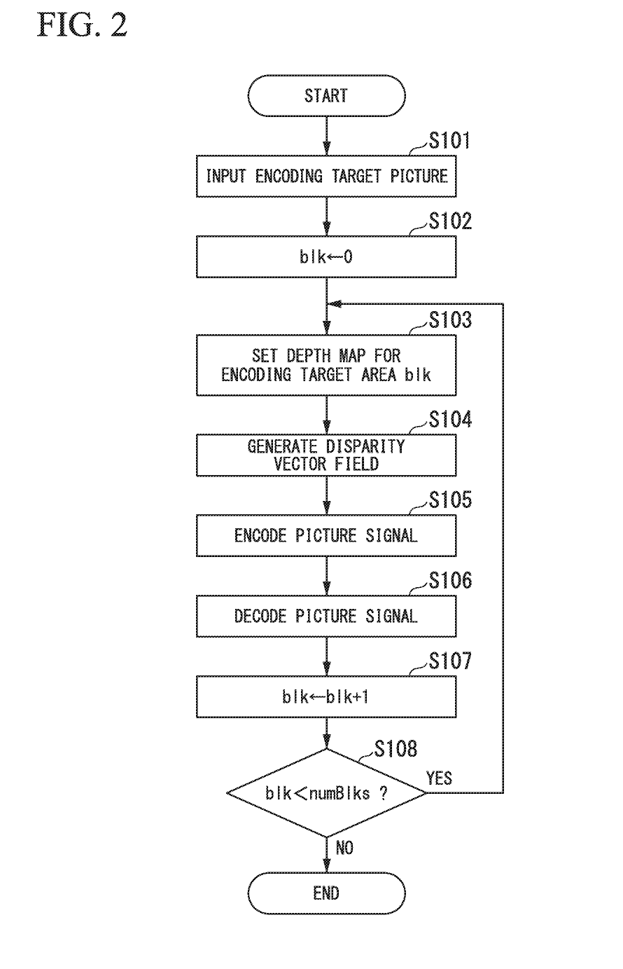

FIG. 2 is a flowchart illustrating an operation of the video encoding apparatus 100 in an embodiment of the present invention.

The encoding target picture input unit 101 inputs an encoding target picture to the encoding target picture memory 102. The encoding target picture memory 102 stores the encoding target picture (step S101).

When the encoding target picture is input, the encoding target picture is divided into areas having a predetermined size, and a video signal of the encoding target picture is encoded for each divided area. Hereinafter, each of the areas into which the encoding target picture is divided is referred to as an “encoding target area”. Although the encoding target picture is divided into processing unit blocks, which are called macroblocks of 16 pixels×16 pixels, in general encoding, the encoding target picture may be divided into blocks having a different size as long as the size is the same as that on the decoding end. Further, the encoding target picture may be divided into blocks having sizes which are different between the areas instead of dividing the entire encoding target picture in the same size (steps S102 to S108).

In FIG. 2, an encoding target area index is denoted as “blk”. The total number of encoding target areas in one frame of the encoding target picture is denoted as “numBlks”. blk is initialized to 0 (step S102).

In a process repeated for each encoding target area, a depth map of the encoding target area blk is first set (step S103).

The depth map is input to the disparity vector field generation unit 104 by the depth map input unit 103. It is to be noted that the input depth map is assumed to be the same as that obtained on the decoding end, such as a depth map obtained by performing decoding on a previously encoded depth map. This is because generation of coding noise such as drift is suppressed by using the same depth map as that obtained on the decoding end. However, if the generation of such coding noise is allowed, a depth map that is obtained only on the encoding end, such as a depth map before encoding, may be input.

Further, in addition to the depth map obtained by performing decoding on the previously encoded depth map, a depth map estimated by applying stereo matching or the like to a multi-view video decoded for a plurality of cameras, or a depth map estimated using a decoded disparity vector, a decoded motion vector, or the like may also be used as the depth map for which the same depth map can be obtained on the decoding end.

Further, although the depth map corresponding to the encoding target area is assumed to be input for each encoding target area in the present embodiment, the depth map of the encoding target area blk may be set by inputting and storing a depth map to be used for the entire encoding target picture in advance and referring to the stored depth map for each encoding target area.

The depth map of the encoding target area blk may be set using any method. For example, when a depth map corresponding to the encoding target picture is used, a depth map in the same position as the encoding target area blk in the encoding target picture may be set, or a depth map in a position shifted by a previously determined or separately designated vector may be set.

It is to be noted that if there is a difference in resolution between the encoding target picture and the depth map corresponding to the encoding target picture, an area scaled in accordance with a resolution ratio may be set or a depth map generated by upsampling, in accordance with the resolution ratio, the area scaled in accordance with the resolution ratio may be set. Further, in a depth map corresponding to the same position as the encoding target area in a picture previously encoded in the encoding target view may be set.

It is to be noted that if one of views different from the encoding target view is set as a depth view and a depth map based on the depth view is used, an estimated disparity PDV between the encoding target view and the depth view in the encoding target area blk is obtained, and a depth map in “blk+PDV” is set. It is to be noted that if there is a difference in resolution between the encoding target picture and the depth map, scaling of the position and the size may be performed in accordance with the resolution ratio.

The estimated disparity PDV between the encoding target view and the depth view in the encoding target area blk may be obtained using any method as long as the method is the same as that on the decoding end. For example, a disparity vector used when an area around the encoding target area blk is encoded, a global disparity vector set for the entire encoding target picture or a partial picture including the encoding target area, or a disparity vector separately set and encoded for each encoding target area may be used. Further, a disparity vector used in a different encoding target area or an encoding target picture previously encoded may be stored, and the stored disparity vector may be used.

Then, the disparity vector field generation unit 104 generates a disparity vector field of the encoding target area blk using the set depth map (step S104). This process will be described in detail below.

The picture encoding unit 106 encodes a video signal (pixel values) of the encoding target picture in the encoding target area blk while performing prediction using the disparity vector field of the encoding target area blk and a picture stored in the reference picture memory 108 (step S105).

The bit stream obtained as a result of the encoding becomes an output of the video encoding apparatus 100. It is to be noted that any method may be used as the encoding method. For example, if general coding such as MPEG-2 or H.264/AVC is used, the picture encoding unit 106 performs encoding by applying frequency transform such as discrete cosine transform (DCT), quantization, binarization, and entropy encoding on a differential signal between the video signal of the encoding target area blk and the predicted picture in order.

It is to be noted that the reference view information input to the picture encoding unit 106 is assumed to be the same as that obtained on the decoding end, such as reference view information obtained by performing decoding on previously encoded reference view information. This is because generation of coding noise such as drift is suppressed by using exactly the same information as the reference view information obtained on the decoding end. However, if the generation of such coding noise is allowed, reference view information that is obtained only on the encoding end, such as reference view information before encoding, may be input.

Further, in addition to the reference view information obtained by performing decoding on the reference view information that has been already encoded, reference view information obtained by analyzing a decoded reference view picture or a depth map corresponding to the reference view picture can be used as the reference view information for which the same reference view information can be obtained on the decoding end. Further, although the necessary reference view information is assumed to be input for each area in the present embodiment, the reference view information to be used for the entire encoding target picture may be input and stored in advance, and the stored reference view information may be referred to for each encoding target area.

The picture decoding unit 107 decodes the video signal for the encoding target area blk and stores a decoding target picture which is a decoding result in the reference picture memory 108 (step S106). The picture decoding unit 107 acquires a generated bit stream and performs decoding on the generated bit stream to generate the decoding target picture. The picture decoding unit 107 may acquire data immediately before the process on the encoding end becomes lossless and the predicted picture, and perform decoding through a simplified process. In either case, the picture decoding unit 107 uses a technique corresponding to the technique used at the time of encoding.

For example, when the picture decoding unit 107 acquires the bit stream and performs a decoding process, if general coding such as MPEG-2 or H.264/AVC is used, the picture decoding unit 107 performs entropy decoding, inverse binarization, inverse quantization, and inverse frequency transform such as inverse discrete cosine transform (IDCT) on the encoded data in order. The picture decoding unit 107 adds the predicted picture to the obtained two-dimensional signal and, finally, clips the obtained value in a range of pixel values to decode a video signal.

In the above-described example, when the picture decoding unit 107 performs decoding through the simplified process, the picture decoding unit 107 may acquire a value after the application of the quantization process at the time of encoding, and a motion-compensated prediction picture, add the motion-compensated prediction picture to a two-dimensional signal obtained by applying inverse quantization and inverse frequency transform on the quantized value in order, and clip the obtained value in a range of pixel values to decode a video signal.

The picture encoding unit 106 adds 1 to blk (step S107).

The picture encoding unit 106 determines whether blk is smaller than numBlks (step S108). If blk is smaller than numBlks (step S108: Yes), the picture encoding unit 106 returns the process to step S103. In contrast, if blk is not smaller than numBlks (step S108: No), the picture encoding unit 106 ends the process.

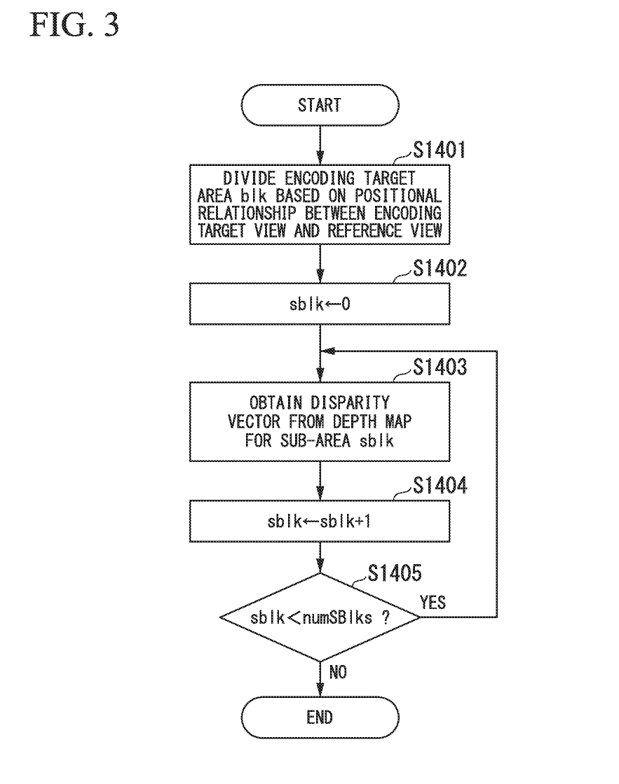

FIG. 3 is a flowchart illustrating a first example of a process (step S104) in which the disparity vector field generation unit 104 generates a disparity vector field in an embodiment of the present invention.

In the process of generating the disparity vector field, the disparity vector field generation unit 104 divides the encoding target area blk into a plurality of sub-areas based on the positional relationship between the encoding target view and the reference view (step S1401). The disparity vector field generation unit 104 identifies the direction of the disparity in accordance with the positional relationship between the views, and divides the encoding target area blk in a direction parallel to the direction of the disparity.

It is to be noted that dividing the encoding target area in the direction parallel to the direction of the disparity means that a boundary line between the divided encoding target areas (division line for dividing the encoding target area) becomes parallel to the direction of the disparity, and means that a plurality of divided encoding target areas are aligned in a direction perpendicular to the direction of the disparity. That is, when the disparity is generated in a horizontal direction, the encoding target area is divided so that a plurality of sub-areas are aligned in a vertical direction.

When the encoding target area is divided, a width in the direction perpendicular to the direction of the disparity may be set to any width as long as the width is the same as that on the decoding end. For example, the width may be set to a previously determined width (for example, 1 pixel, 2 pixels, 4 pixels, or 8 pixels), or the width may be set by analyzing the depth map. Further, the same width may be set in all sub-areas, or different widths may be set. For example, the widths may be set by performing clustering based on the values of the depth map in the sub-areas. Further, the direction of the disparity may be obtained as an angle of arbitrary precision or may be selected from discretized angles. For example, the direction of the disparity may be selected from either a horizontal direction or a vertical direction. In this case, the area division is performed either vertically or horizontally.

It is to be noted that each encoding target area may be divided into the same number of sub-areas, or each encoding target area may be divided into a different number of sub-areas.

When the division into the sub-areas is completed, the disparity vector field generation unit 104 obtains the disparity vector from the depth map for each sub-area (steps S1402 to S1405).

The disparity vector field generation unit 104 initializes a sub-area index “sblk” to 0 (step S1402).

The disparity vector field generation unit 104 obtains the disparity vector from the depth map of the sub-area sblk (step S1403). It is to be noted that a plurality of disparity vectors may be set for one sub-area sblk. Any method may be used as a method for obtaining the disparity vector from the depth map of the sub-area sblk. For example, the disparity vector field generation unit 104 may obtain the disparity vector by obtaining a representative depth value (representative depth rep) expressing the sub-area sblk, and converting the depth value to a disparity vector. A plurality of disparity vectors can be set by setting a plurality of representative depths for one sub-area sblk and setting disparity vectors obtained from the representative depths.

Typical methods for setting the representative depth rep include a method using an average value, a mode value, a median, a maximum value, a minimum value, or the like in the depth map of the sub-area sblk. Further, rather than all pixels in the sub-area sblk, an average value, a median, a maximum value, a minimum value, or the like of depth values corresponding to part of the pixels may also be used. As the part of the pixels, pixels at four vertices determined for the sub-area sblk, pixels at four vertices and a center, or the like may be used. Further, there is a method using a depth value corresponding to a previously determined position for the sub-area sblk, such as the upper left or a center.

The disparity vector field generation unit 104 adds 1 to sblk (step S1404). The disparity vector field generation unit 104 determines whether sblk is smaller than numSBlks. numSBlks indicates the number of sub-areas within the encoding target area blk (step S1405). If sblk is smaller than numSBlks (step S1405: Yes), the disparity vector field generation unit 104 returns the process to step S1403. That is, the disparity vector field generation unit 104 repeats “steps S1403 to S1405” that obtain the disparity vector from the depth map for each of the sub-areas obtained by the division. In contrast, if sblk is not smaller than numSBlks (step S1405: No), the disparity vector field generation unit 104 ends the process.

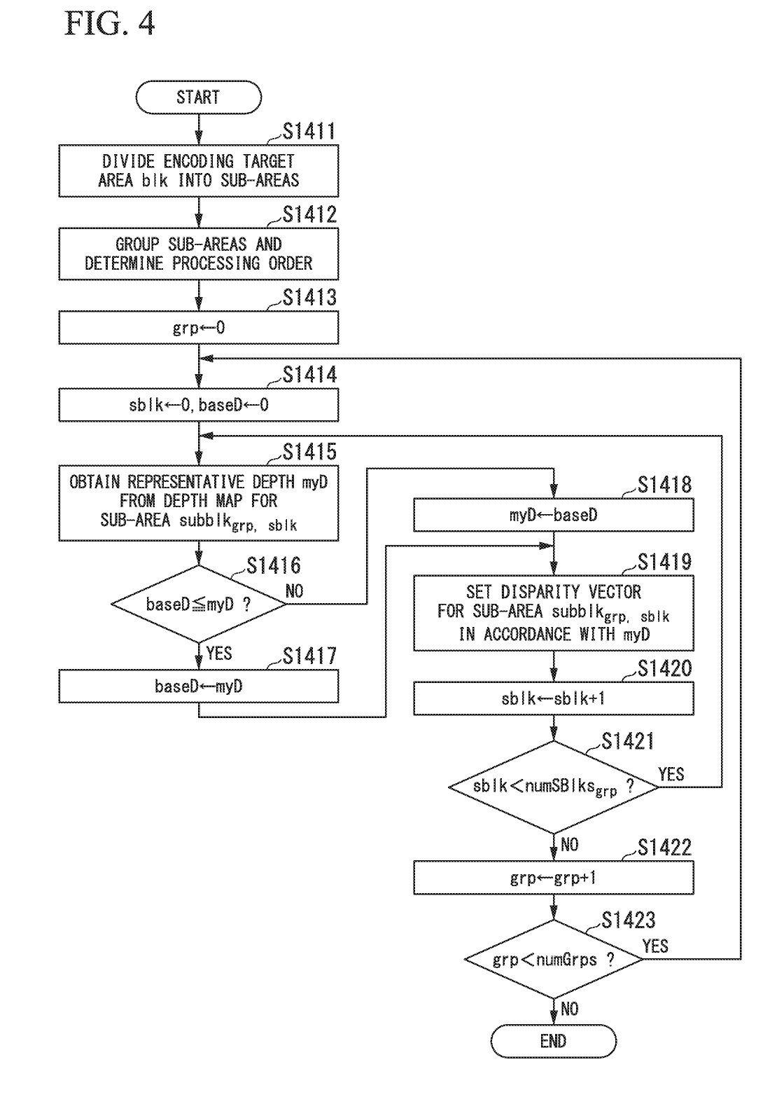

FIG. 4 is a flowchart illustrating a second example of a process (step S104) in which the disparity vector field generation unit 104 generates a disparity vector field in an embodiment of the present invention.

In the process of generating the disparity vector field, the disparity vector field generation unit 104 divides the encoding target area blk into a plurality of sub-areas (step S1411).

The encoding target area blk may be divided into any type of sub-area as long as the sub-areas are the same as those on the decoding end. For example, the disparity vector field generation unit 104 may divide the encoding target area blk into a set of sub-areas having a previously determined size (for example, 1 pixel, 2×2 pixels, 4×4 pixels, 8×8 pixels, or 4×8 pixels) or may divide the encoding target area blk by analyzing the depth map.

As a method for dividing the encoding target area blk by analyzing the depth map, the disparity vector field generation unit 104 may divide the encoding target area blk so that a variance of the depth map within the same sub-area is as small as possible. As another method, values of the depth map corresponding to a plurality of pixels determined for the encoding target area blk may be compared with one another and a method for dividing the encoding target area blk may be determined. Further, the encoding target area blk may be divided into rectangular areas having a previously determined size, pixel values of four vertices determined in each rectangular area may be checked for each rectangular area, and each rectangular area may be divided.

It is to be noted that as in the above-described example, the disparity vector field generation unit 104 may divide the encoding target area blk into the sub-areas based on the positional relationship between the encoding target view and the reference view. For example, the disparity vector field generation unit 104 may determine an aspect ratio of the sub-area or the above-described rectangular area based on the direction of the disparity.

If the encoding target area blk is divided into the sub-areas, the disparity vector field generation unit 104 groups the sub-areas based on the positional relationship between the encoding target view and the reference view, and determines an order (processing order) of the sub-areas (step S1412). Here, the disparity vector field generation unit 104 identifies the direction of the disparity in accordance with the positional relationship between the views. The disparity vector field generation unit 104 determines a group of sub-areas present in a direction parallel to the direction of the disparity, as the same group. The disparity vector field generation unit 104 determines, for each group, an order of the sub-areas included in each group in accordance with a direction in which an occlusion occurs. Hereinafter, the disparity vector field generation unit 104 is assumed to determine the order of the sub-areas in accordance with the same direction as that of the occlusion.

Here, when an object area on the encoding target picture corresponding to an object occluding, when viewed from the reference view, an occlusion area on the encoding target picture corresponding to an area that can be observed from the encoding target view but cannot be observed from the reference view is set for the occlusion area, the direction of the occlusion refers to a direction on the encoding target picture from the object area to the occlusion area.

For example, if there are two cameras directed in the same direction and camera A corresponding to the reference view is present to the left of camera B corresponding to the encoding target view, a horizontal right direction on the encoding target picture becomes the direction of the occlusion. It is to be noted that if the encoding target view and the reference view are arranged one-dimensionally parallel, the direction of the occlusion matches the direction of the disparity. However, the disparity referred to here is expressed using a position on the encoding target picture as a starting point.

Hereinafter, an index indicating a group is referred to as “grp”. The number of generated groups is referred to as “numGrps”. An index indicating a sub-area in the group in accordance with the order is referred to as “sblk”. The number of sub-areas included in the group grp is referred to as “numSBlks_{grp}”. The sub-area having the index sblk within the group grp is referred to as “subblk_{grp,sblk}”.

If the disparity vector field generation unit 104 groups the sub-areas and determines the order of the sub-areas, the disparity vector field generation unit 104 determines, for each group, a disparity vector for the sub-areas included in each group (steps S1413 to S1423).

The disparity vector field generation unit 104 initializes the group grp to 0 (step S1413).

The disparity vector field generation unit 104 initializes the index sblk to 0. The disparity vector field generation unit 104 initializes a base depth baseD within the group to 0 (step S1414).

The disparity vector field generation unit 104 repeats a process (steps S1415 to S1419) of obtaining the disparity vector from the depth map, for each sub-area in the group grp. It is to be noted that the value of the depth is assumed to be a value greater than or equal to 0. The value “0” of the depth is assumed to indicate the greatest distance from the view to the object. That is, it is assumed that the depth value “0” increases as the distance from the view to the object decreases.

When the magnitude of the depth value is defined in reverse, that is, when the value is defined to be smaller as the distance from the view to the object decreases, the value of the depth is not initialized to a value 0, but is initialized to a maximum value of the depth. In this case, it is necessary for a comparison between the magnitudes of the depth values to appropriately read in reverse, as compared with a case in which the value “0” indicates that the distance from the view to the object is greatest.

In a process repeated for each sub-area within the group grp, the disparity vector field generation unit 104 obtains a representative depth myD based on a sub-area subblk_{grp,sblk} from the depth map of the sub-area subblk_{grp,sblk} (step S1415). The representative depth is, for example, an average value, a median, a minimum value, a maximum value, or a mode value in the depth map of the sub-area subblk_{grp,sblk}. Further, the representative depth may be a depth value corresponding to all pixels of the sub-area or may be a depth value corresponding to part of the pixels such as pixels at four vertices determined in the sub-area subblk_{grp,sblk} or pixels located in the four vertices and a center.

The disparity vector field generation unit 104 determines whether the representative depth myD is greater than or equal to the base depth baseD (determines an occlusion with a sub-area processed prior to the sub-area subblk_{grp},) (step S1416). If the representative depth myD is greater than or equal to the base depth baseD (if it is indicated that the representative depth myD for the sub-area subblk_{grp,sblk} is closer to the view than the base depth baseD, which is a representative depth for the sub-area processed prior to the sub-area subblk_{grp,sblk}) (step S1416: Yes), the disparity vector field generation unit 104 updates the base depth baseD with the representative depth myD (step S1417).

If the representative depth myD is smaller than the base depth baseD (step S1416: No), the disparity vector field generation unit 104 updates the representative depth myD with the base depth baseD (step S1418).

The disparity vector field generation unit 104 calculates a disparity vector based on the representative depth myD. The disparity vector field generation unit 104 determines the calculated disparity vector as the disparity vector of the sub-area subblk_{grp,sblk} (step S1419).

It is to be noted that in FIG. 4, the disparity vector field generation unit 104 obtains the representative depth for each sub-area and calculates the disparity vector based on the representative depth, but the disparity vector field generation unit 104 may directly calculate the disparity vector from the depth map. In this case, the disparity vector field generation unit 104 stores and updates a base disparity vector instead of the base depth. Further, the disparity vector field generation unit 104 may obtain a representative disparity vector for each sub-area instead of the representative depth, compare the base disparity vector with the representative disparity vector (compares the disparity vector for the sub-area with a disparity vector for a sub-area processed prior to the sub-area), and execute updating of the base disparity vector and changing of the representative disparity vector.

A criterion for this comparison and a method for updating or changing depend on an arrangement of the encoding target view and the reference view. If the encoding target view and the reference view are arranged one-dimensionally parallel, the disparity vector field generation unit 104 determines the base disparity vector and the representative disparity vector so that the vectors increase (sets a larger disparity vector among a disparity vector for a sub-area and a disparity vector for a sub-area processed prior to the sub-area, as the representative disparity vector). It is to be noted that the disparity vector is expressed using the direction of the occlusion set as a positive direction and a position on the encoding target picture set as a starting point.

It is to be noted that the updating of the base depth may be achieved using any method. For example, the disparity vector field generation unit 104 may forcibly update the base depth in accordance with the distance between the sub-area in which the base depth has lastly been updated and the currently processed sub-area, instead of always comparing the magnitudes of the representative depth and the base depth and updating the base depth or changing the representative depth.

For example, in step S1417, the disparity vector field generation unit 104 stores the position of a sub-area baseBlk based on the base depth. Before executing step S1418, the disparity vector field generation unit 104 may determinate whether the difference between the position of the sub-area baseBlk and the position of the sub-area subblk_{grp,sblk} is larger than the disparity vector based on the base depth. If the difference is greater than the disparity vector based on the base depth, the disparity vector field generation unit 104 performs a process of updating the base depth (step S1417). In contrast, if the difference is not greater than the disparity vector based on the base depth, the disparity vector field generation unit 104 executes a process of changing the representative depth (step S1418).

The disparity vector field generation unit 104 adds 1 to sblk (step S1420).

The disparity vector field generation unit 104 determines whether sblk is smaller than numSBlks_{grp} (step S1421). If sblk is smaller than numSBlks_{grp} (step S1421: Yes), the disparity vector field generation unit 104 returns the process to step S1415.

In contrast, if sblk is greater than or equal to numSBlks_{grp} (step S1421: No), the disparity vector field generation unit 104 repeats the process (S1414 to S1421) of obtaining the disparity vector based on the depth map in an order determined for each sub-area included in the group grp.

The disparity vector field generation unit 104 adds 1 to the group grp (step S1422). The disparity vector field generation unit 104 determines whether the group grp is smaller than numGrps (step S 1423). If the group grp is smaller than numGrps (step S1423: Yes), the disparity vector field generation unit 104 returns the process to step S1414. In contrast, if the group grp is greater than or equal to numGrps (step S1423: No), the disparity vector field generation unit 104 ends the process.

Next, decoding will be described.

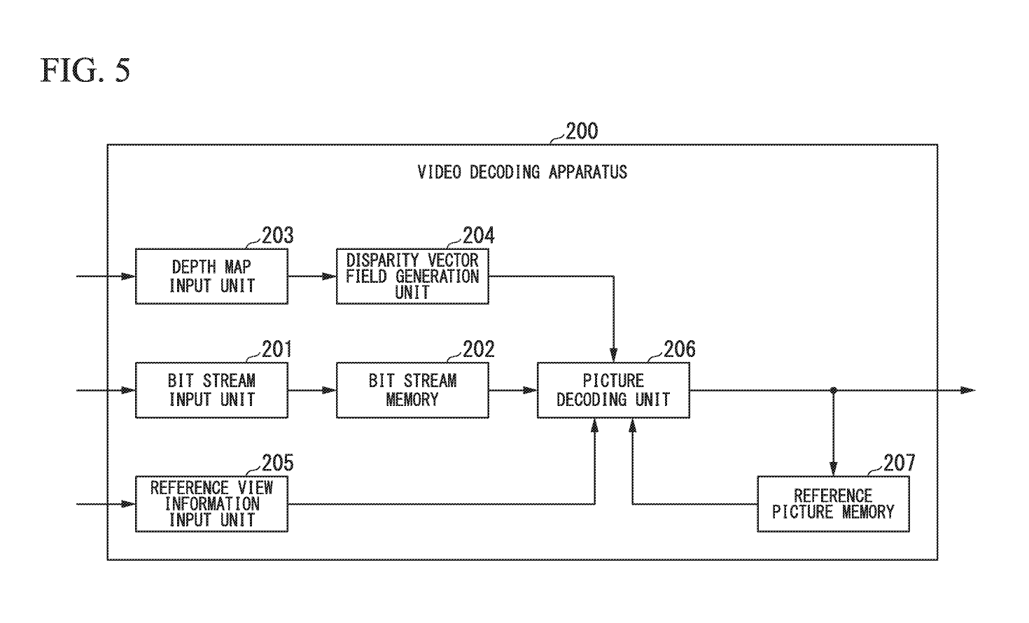

FIG. 5 is a block diagram illustrating a configuration of a video decoding apparatus in an embodiment of the present invention. The video decoding apparatus 200 includes a bit stream input unit 201, a bit stream memory 202, a depth map input unit 203, a disparity vector field generation unit 204 (a disparity vector setting unit, a processing direction setting unit, a representative depth setting unit, an area division setting unit, and an area division unit), a reference view information input unit 205, a picture decoding unit 206, and a reference picture memory 207.

The bit stream input unit 201 inputs a bit stream encoded by the video encoding apparatus 100, that is, a bit stream of a video which is a decoding target to the bit stream memory 202. The bit stream memory 202 stores the bit stream of the video which is the decoding target. Hereinafter, a picture included in the video which is the decoding target is referred to as a “decoding target picture”. The decoding target picture is a picture included in a video (decoding target picture group) captured by camera B. Further, hereinafter, a view from camera B capturing the decoding target picture is referred to as a “decoding target view”.

The depth map input unit 203 inputs a depth map to be referred to when a disparity vector based on a correspondence relationship of pixels between the views is obtained, to the disparity vector field generation unit 204. Here, although the depth map corresponding to the decoding target picture is input, a depth map in another view (for example, reference view) may be input.

It is to be noted that the depth map represents a three-dimensional position of an object included in the decoding target picture for each pixel. The depth map may be expressed using, for example, the distance from a camera to the object, a coordinate value of an axis which is not parallel to the picture plane, or an amount of disparity with respect to another camera (for example, camera A). Here, although the depth map is passed in the form of the picture, the depth map may not be passed in the form of the picture as long as the same information can be obtained.

The disparity vector field generation unit 204 generates, from the depth map, a disparity vector field between an area included in the decoding target picture and an area included in reference view information associated with the decoding target picture. The reference view information input unit 205 inputs information based on a picture included in a video captured from a view (camera A) different from the decoding target picture, that is, the reference view information, to the picture decoding unit 206. The picture included in the video based on the view different from the decoding target picture is a picture referred to when the decoding target picture is decoded. Hereinafter, the view of the picture referred to when the decoding target picture is decoded is referred to as a “reference view”. A picture in the reference view is referred to as a “reference view picture”. The reference view information is, for example, information based on a target predicted when the decoding target picture is decoded.

The picture decoding unit 206 decodes a decoding target picture from the bit stream based on the decoding target picture (reference view picture) stored in the reference picture memory 207, the generated disparity vector field, and the reference view information.

The reference picture memory 207 stores the decoding target picture decoded by the picture decoding unit 206, as a reference view picture.

Next, an operation of the video decoding apparatus 200 will be described.

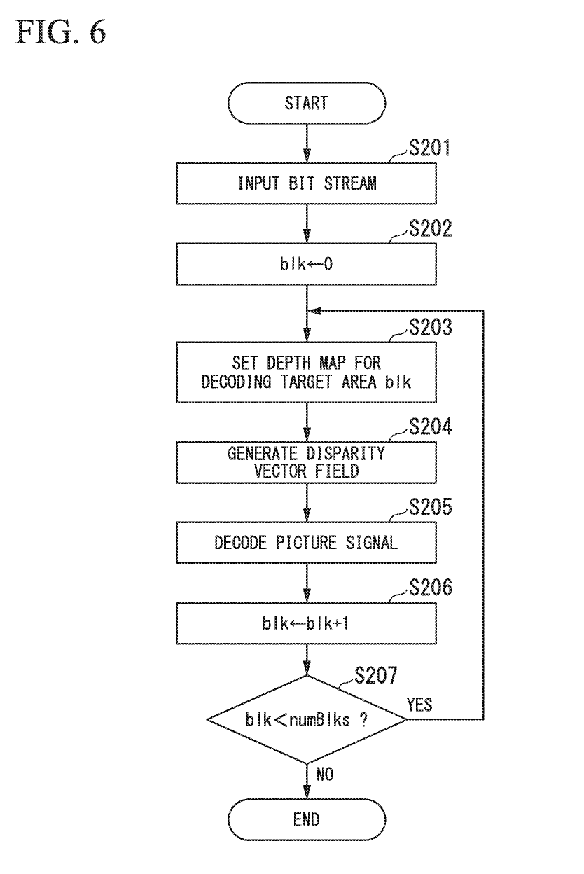

FIG. 6 is a flowchart illustrating an operation of the video decoding apparatus 200 in an embodiment of the present invention.

The bit stream input unit 201 inputs a bit stream obtained by encoding a decoding target picture to the bit stream memory 202. The bit stream memory 202 stores the bit stream obtained by encoding the decoding target picture. The reference view information input unit 205 inputs reference view information to the picture decoding unit 206 (step S201).

It is to be noted that the reference view information input here is assumed to be the same reference view information as that used on the encoding end. This is because generation of coding noise such as drift is suppressed by using exactly the same information as the reference view information used at the time of encoding. However, if the generation of such coding noise is allowed, reference view information different from the reference view information used at the time of encoding may be input. Further, in addition to the reference view information obtained by performing decoding on the previously encoded reference view information, reference view information obtained by analyzing the decoded reference view picture or the depth map corresponding to the reference view picture may also be used as reference view information for which the same reference view information can be obtained on the decoding end.

Further, while the reference view information is input to the picture decoding unit 206 for each area in the present embodiment, the reference view information to be used for the entire decoding target picture may be input and stored in advance, and the picture decoding unit 206 may refer to the stored reference view information for each area.

When the bit stream and the reference view information are input, the picture decoding unit 206 divides the decoding target picture into areas having a predetermined size, and decodes a video signal of the decoding target picture from the bit stream for each divided area. Hereinafter, each of the areas into which the decoding target picture is divided is referred to as a “decoding target area”. The decoding target picture is divided into processing unit blocks, which are called macroblocks of 16 pixels×16 pixels, in general decoding, but the decoding target picture may be divided into blocks having a different size as long as the size is the same as that on the encoding end. Further, the picture decoding unit 206 may divide the decoding target picture into blocks having sizes which are different between the areas instead of dividing the entire decoding target picture in the same size (steps S202 to S207).

In FIG. 6, a decoding target area index is indicated by “blk”. The total number of decoding target areas in one frame of the decoding target picture is indicated by “numBlks”. blk is initialized to 0 (step S202).

In the process repeated for each decoding target area, a depth map of the decoding target area blk is first set (step S203). This depth map is input by the depth map input unit 203. It is to be noted that the input depth map is assumed to be the same depth map as that used on the encoding end. This is because generation of coding noise such as drift is suppressed by using the same depth map as that used on the encoding end. However, if the generation of such coding noise is allowed, a depth map different from that on the encoding end may be input.

As the same depth map as that used on the encoding end, a depth map estimated by applying stereo matching or the like to a multi-view video decoded for a plurality of cameras, a depth map estimated using, for example, a decoded disparity vector or a decoded motion vector, or the like, instead of the depth map separately decoded from the bit stream, can be used.

Further, although the depth map of the decoding target area is input to the picture decoding unit 206 for each decoding target area in the present embodiment, the depth map to be used for the entire decoding target picture may be input and stored in advance, and the picture decoding unit 206 may set the depth map of the decoding target area blk by referring to the stored depth map for each decoding target area.

The depth map of the decoding target area blk may be set using any method. For example, if a depth map corresponding to the decoding target picture is used, a depth map in the same position as that of the decoding target area blk in the decoding target picture may be set, or a depth map in a position shifted by a previously determined or separately designated vector may be set.

It is to be noted that if there is a difference in resolution between the decoding target picture and the depth map corresponding to the decoding target picture, an area scaled in accordance with a resolution ratio may be set or a depth map generated by upsampling, in accordance with the resolution ratio, the area scaled in accordance with the resolution ratio may be set. Further, a depth map corresponding to the same position as the decoding target area in a picture previously decoded for the decoding target view may be set.

It is to be noted that if one of views different from the decoding target view is set as a depth view and a depth map in the depth view is used, an estimated disparity PDV between the decoding target view and the depth view in the decoding target area blk is obtained, and a depth map in “blk+PDV” is set. It is to be noted that if there is a difference in resolution between the decoding target picture and the depth map, scaling of the position and the size may be performed in accordance with the resolution ratio.

The estimated disparity PDV between the decoding target view and the depth view in the decoding target area blk may be obtained using any method as long as the method is the same as that on the encoding end. For example, a disparity vector used when an area around the decoding target area blk is decoded, a global disparity vector set for the entire decoding target picture or a partial picture including the decoding target area, or an encoded disparity vector separately set for each decoding target area can be used. Further, a disparity vector used in a different decoding target area or a decoding target picture previously decoded may be stored, and the stored disparity vector may be used.

Then, the disparity vector field generation unit 204 generates the disparity vector field in the decoding target area blk (step S204). This process is the same as step S104 described above except that the encoding target area is read as the decoding target area.

The picture decoding unit 206 decodes a video signal (pixel values) in the decoding target area blk from the bit stream while performing prediction using the disparity vector field of the decoding target area blk, the reference view information input from the reference view information input unit 205, and a reference view picture stored in the reference picture memory 207 (step S205).

The obtained decoding target picture is stored in the reference picture memory 207 and becomes an output of the video decoding apparatus 200. It is to be noted that a method corresponding to the method used at the time of encoding is used for decoding of the video signal. For example, if general coding such as MPEG-2 or H.264/AVC is used, the picture decoding unit 206 applies entropy decoding, inverse binarization, inverse quantization, and inverse frequency transform such as inverse discrete cosine transform to the bit stream in order, adds the predicted picture to the obtained two-dimensional signal, and, finally, clips the obtained value in a range of pixel values, to decode the video signal from the bit stream.

It is to be noted that the reference view information is a reference view picture, a vector field based on the reference view picture, or the like. This vector is, for example, a motion vector. If the reference view picture is used, the disparity vector field is used for disparity-compensated prediction. If the vector field based on the reference view picture is used, the disparity vector field is used for inter-view vector prediction. It is to be noted that other information (for example, a block division method, a prediction mode, an intra prediction direction, or an in-loop filter parameter) may also be used for prediction. Further, a plurality of pieces of information may be used for prediction.

The picture decoding unit 206 adds 1 to blk (step S206).

The picture decoding unit 206 determines whether blk is smaller than numBlks (step S207). If blk is smaller than numBlks (step S207: Yes), the picture decoding unit 206 returns the process to step S203. In contrast, if blk is not smaller than numBlks (step S207: No), the picture decoding unit 206 ends the process.

While the generation of the disparity vector field has been performed for each of the areas into which the encoding target picture or the decoding target picture has been divided in the above-described embodiment, the disparity vector field may be generated and stored for all areas of the encoding target picture or the decoding target picture in advance, and the stored disparity vector field may be referred to for each area.

While the process of encoding or decoding the entire picture has been described in the above-described embodiment, the process may be applied to only part of the picture. In this case, a flag indicating whether the process is applied may be encoded or decoded. Further, the flag indicating whether the process is applied may be designated as any other means. For example, whether the process is applied may be indicated as one of modes indicating a technique of generating a predicted picture for each area.

Next, an example of a hardware configuration when the video encoding apparatus and the video decoding apparatus are configured with a computer and a software program will be described.

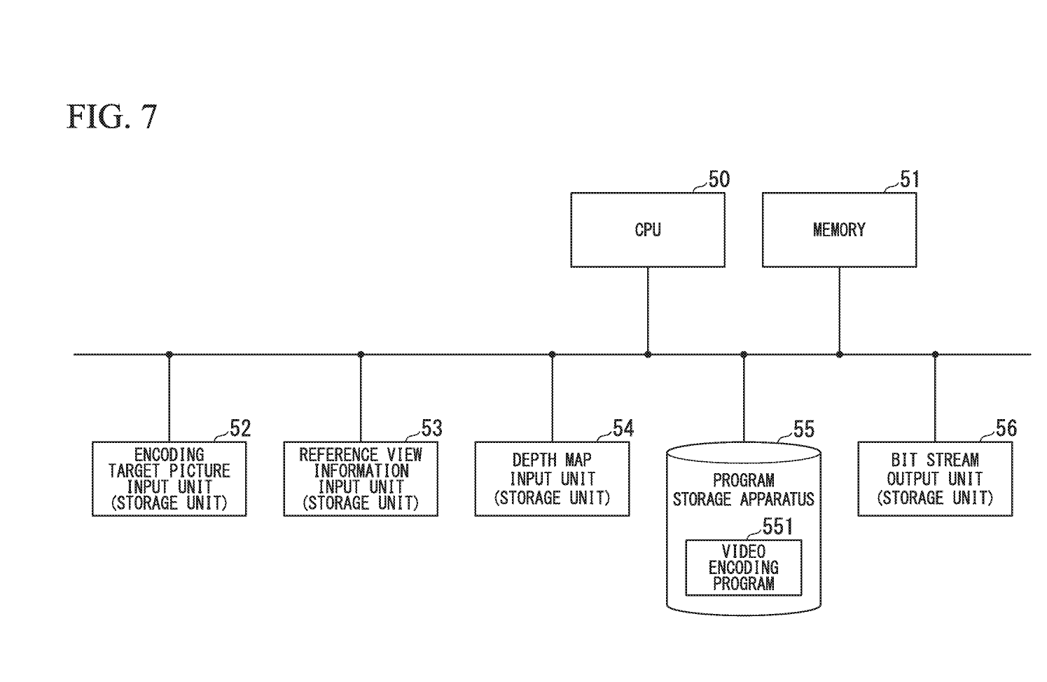

FIG. 7 is a block diagram illustrating an example of a hardware configuration when the video encoding apparatus 100 is configured with a computer and a software program in an embodiment of the present invention. A system includes a central processing unit (CPU) 50, a memory 51, an encoding target picture input unit 52, a reference view information input unit 53, a depth map input unit 54, a program storage apparatus 55, and a bit stream output unit 56. Each unit is communicably connected via a bus.

The CPU 50 executes the program. The memory 51 is, for example, a random access memory (RAM) in which a program and data accessed by the CPU 50 is stored. The encoding target picture input unit 52 inputs a video signal which is an encoding target to the CPU 50 from camera B or the like. The encoding target picture input unit 52 may be a storage unit such as a disk apparatus which stores the video signal. The reference view information input unit 53 inputs a video signal from the reference view such as camera A to the CPU 50. The reference view information input unit 53 may be a storage unit such as a disk apparatus which stores the video signal. The depth map input unit 54 inputs a depth map in a view in which an object is photographed by a depth camera or the like, to the CPU 50. The depth map input unit 54 may be a storage unit such as a disk apparatus which stores the depth map. The program storage apparatus 55 stores a video encoding program 551, which is a software program that causes the CPU 50 to execute a video encoding process.

The bit stream output unit 56 outputs a bit stream generated by the CPU 50 executing the video encoding program 551 loaded from the program storage apparatus 55 into the memory 51, for example, over a network. The bit stream output unit 56 may be a storage unit such as a disk apparatus which stores the bit stream.

The encoding target picture input unit 101 corresponds to the encoding target picture input unit 52. The encoding target picture memory 102 corresponds to the memory 51. The depth map input unit 103 corresponds to the depth map input unit 54. The disparity vector field generation unit 104 corresponds to the CPU 50. The reference view information input unit 105 corresponds to the reference view information input unit 53. The picture encoding unit 106 corresponds to the CPU 50. The picture decoding unit 107 corresponds to the CPU 50. The reference picture memory 108 corresponds to the memory 51.

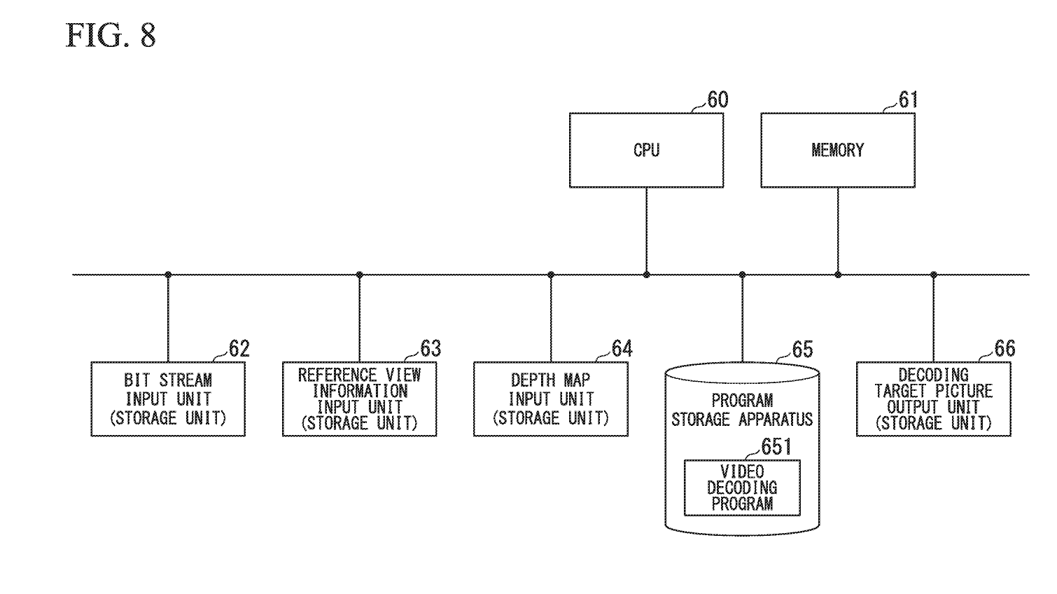

FIG. 8 is a block diagram illustrating an example of a hardware configuration when the video decoding apparatus 200 is configured with a computer and a software program in an embodiment of the present invention. A system includes a CPU 60, a memory 61, a bit stream input unit 62, a reference view information input unit 63, a depth map input unit 64, a program storage apparatus 65, and a decoding target picture output unit 66. Each unit is communicably connected via a bus.

The CPU 60 executes the program. The memory 61 is, for example, a RAM in which a program and data accessed by the CPU 60 is stored. The bit stream input unit 62 inputs the bit stream encoded by the video encoding apparatus 100 to the CPU 60. The bit stream input unit 62 may be a storage unit such as a disk apparatus which stores the bit stream. The reference view information input unit 63 inputs a video signal from the reference view such as camera A to the CPU 60. The reference view information input unit 63 may be a storage unit such as a disk apparatus which stores the video signal.

The depth map input unit 64 inputs a depth map in a view in which an object is photographed by a depth camera or the like, to the CPU 60. The depth map input unit 64 may be a storage unit such as a disk apparatus which stores the depth map. The program storage apparatus 65 stores a video decoding program 651, which is a software program that causes the CPU 60 to execute a video decoding process. The decoding target picture output unit 66 outputs a decoding target picture obtained by performing decoding on the bit stream by the CPU 60 executing the video decoding program 651 loaded into the memory 61 to a reproduction apparatus or the like. The decoding target picture output unit 66 may be a storage unit such as a disk apparatus which stores the video signal.

The bit stream input unit 201 corresponds to the bit stream input unit 62. The bit stream memory 202 corresponds to the memory 61. The reference view information input unit 205 corresponds to the reference view information input unit 63. The reference picture memory 207 corresponds to the memory 61. The depth map input unit 203 corresponds to the depth map input unit 64. The disparity vector field generation unit 204 corresponds to the CPU 60. The picture decoding unit 206 corresponds to the CPU 60.

The video encoding apparatus 100 and the video decoding apparatus 200 in the above-described embodiment may be achieved by a computer. In this case, the apparatus may be achieved by recording a program for achieving the above-described functions on a computer-readable recording medium, loading the program recorded on the recording medium into a computer system, and executing the program. It is to be noted that the “computer system” referred to here includes an operating system (OS) and hardware such as a peripheral device. Further, the “computer-readable recording medium” refers to a portable medium such as a flexible disk, a magneto-optical disc, a read only memory (ROM), or a compact disc (CD)-ROM, or a storage apparatus such as a hard disk embedded in the computer system. Further, the “computer-readable recording medium” may also include a recording medium that dynamically holds a program for a short period of time, such as a communication line when the program is transmitted over a network such as the Internet or a communication line such as a telephone line, or a recording medium that holds a program for a certain period of time, such as a volatile memory inside a computer system which functions as a server or a client in such a case. Further, the program may be a program for achieving part of the above-described functions or may be a program capable of achieving the above-described functions through a combination with a program pre-stored in the computer system. Further, the video encoding apparatus 100 and the video decoding apparatus 200 may be achieved using a programmable logic device such as a field programmable gate array (FPGA).

While an embodiment of the present invention has been described above in detail with reference to the accompanying drawings, a specific configuration is not limited to the embodiment, and designs and the like without departing from the gist of the present invention are also included.

### INDUSTRIAL APPLICABILITY

The present invention can be applied to, for example, encoding and decoding of the free viewpoint video. In accordance with the present invention, it is possible to improve the accuracy of the inter-view prediction of the video signal and the motion vector and improve the efficiency of the video coding in coding of free viewpoint video data having videos for a plurality of views and depth maps as components.

### DESCRIPTION OF REFERENCE SIGNS

50 CPU
51 memory
52 encoding target picture input unit
53 reference view information input unit
54 depth map input unit
55 program storage apparatus
56 bit stream output unit
60 CPU
61 memory
62 bit stream input unit
63 reference view information input unit
64 depth map input unit
65 program storage apparatus
66 decoding target picture output unit
100 video encoding apparatus
101 encoding target picture input unit
102 encoding target picture memory
103 depth map input unit
104 disparity vector field generation unit
105 reference view information input unit
106 picture encoding unit
107 picture decoding unit
108 reference picture memory
200 video decoding apparatus
201 bit stream input unit
202 bit stream memory
203 depth map input unit
204 disparity vector field generation unit
205 reference view information input unit
206 picture decoding unit
207 reference picture memory
551 video encoding program
651 video decoding program

1. A video encoding apparatus which, when encoding an encoding target picture which is one frame of a multi-view video including videos of a plurality of different views, performs predictive encoding from a reference view different from a view of the encoding target picture, for each encoding target area which is one of areas into which the encoding target picture is divided, using a depth map for an object in the multi-view video, the video encoding apparatus comprising:
an area division setting unit which determines a division method of the encoding target area based on a positional relationship between the view of the encoding target picture and the reference view; and
a disparity vector setting unit which sets a disparity vector for the reference view using the depth map, for each of sub-areas obtained by dividing the encoding target area in accordance with the division method.

2. The video encoding apparatus according to claim 1, further comprising a representative depth setting unit which sets a representative depth from the depth map for each of the sub-areas,
wherein the disparity vector setting unit sets the disparity vector based on the representative depth set for each of the sub-areas.

3. The video encoding apparatus according to claim 1, wherein the area division setting unit sets a direction of a division line for dividing the encoding target area to the same direction as the direction of a disparity generated between the view of the encoding target picture and the reference view.

4. A video encoding apparatus which, when encoding an encoding target picture which is one frame of a multi-view video including videos of a plurality of different views, performs predictive encoding from a reference view different from a view of the encoding target picture, for each encoding target area which is one of areas into which the encoding target picture is divided, using a depth map for an object in the multi-view video, the video encoding apparatus comprising:
an area division unit which divides the encoding target area into a plurality of sub-areas;
a processing direction setting unit which sets a processing order of the sub-areas based on a positional relationship between the view of the encoding target picture and the reference view; and
a disparity vector setting unit which sets a disparity vector for the reference view using the depth map for each of the sub-areas in accordance with the order while determining an occlusion with a sub-area processed prior to each of the sub-areas.

5. The video encoding apparatus according to claim 4, wherein the processing direction setting unit sets the order in the same direction as the direction of the disparity generated between the view of the encoding target picture and the reference view for each set of the sub-areas present in the same direction as the direction of the disparity.

6. The video encoding apparatus according to claim 4, wherein the disparity vector setting unit compares a disparity vector for the sub-area processed prior to each of the sub-areas with a disparity vector set for each of the sub-areas using the depth map and sets a disparity vector having a larger size as the disparity vector for the reference view.

7. The video encoding apparatus according to claim 4, further comprising a representative depth setting unit which sets a representative depth from the depth map for each of the sub-areas,
wherein the disparity vector setting unit compares the representative depth for the sub-area processed prior to each of the sub-areas with the representative depth set for each of the sub-areas, and sets the disparity vector based on the representative depth which indicates being closer to the view of the encoding target picture.

8. A video decoding apparatus which, when decoding a decoding target picture from encoded data of a multi-view video including videos of a plurality of different views, performs decoding while performing prediction from a reference view different from a view of the decoding target picture, for each decoding target area which is one of areas into which the decoding target picture is divided, using a depth map for an object in the multi-view video, the video decoding apparatus comprising:
an area division setting unit which determines a division method of the decoding target area based on a positional relationship between the view of the decoding target picture and the reference view; and
a disparity vector setting unit which sets a disparity vector for the reference view using the depth map, for each of sub-areas obtained by dividing the decoding target area in accordance with the division method.

9. The video decoding apparatus according to claim 8, further comprising a representative depth setting unit which sets a representative depth from the depth map for each of the sub-areas, wherein the disparity vector setting unit sets the disparity vector based on the representative depth set for each of the sub-areas.

10. The video decoding apparatus according to claim 8, wherein the area division setting unit sets a direction of a division line for dividing the decoding target area to the same direction as the direction of a disparity generated between the view of the decoding target picture and the reference view.

11. A video decoding apparatus which, when decoding a decoding target picture from encoded data of a multi-view video including videos of a plurality of different views, performs decoding while performing prediction from a reference view different from a view of the decoding target picture, for each decoding target area which is one of areas into which the decoding target picture is divided, using a depth map for an object in the multi-view video, the video decoding apparatus comprising:
an area division unit which divides the decoding target area into a plurality of sub-areas;
a processing direction setting unit which sets a processing order of the sub-areas based on a positional relationship between the view of the decoding target picture and the reference view; and
a disparity vector setting unit which sets a disparity vector for the reference view using the depth map for each of the sub-areas in accordance with the order while determining an occlusion with a sub-area processed prior to each of the sub-areas.

12. The video decoding apparatus according to claim 11, wherein the processing direction setting unit sets the order in the same direction as the direction of the disparity generated between the view of the decoding target picture and the reference view for each set of the sub-areas present in the same direction as the direction of the disparity.

13. The video decoding apparatus according to claim 11, wherein the disparity vector setting unit compares a disparity vector for the sub-area processed prior to each of the sub-areas with the disparity vector set using the depth map for each of the sub-areas and sets a disparity vector having a larger size as the disparity vector for the reference view.

14. The video decoding apparatus according to claim 11, further comprising a representative depth setting unit which sets a representative depth from the depth map for each of the sub-areas,
wherein the disparity vector setting unit compares the representative depth for the sub-area processed prior to each of the sub-areas with the representative depth set for each of the sub-areas, and sets the disparity vector based on the representative depth which indicates being closer to the view of the decoding target picture.

15. A video encoding method for, when encoding an encoding target picture which is one frame of a multi-view video including videos of a plurality of different views, performing predictive encoding from a reference view different from a view of the encoding target picture, for each encoding target area which is one of areas into which the encoding target picture is divided, using a depth map for an object in the multi-view video, the video encoding method comprising:
an area division setting step of determining a division method of the encoding target area based on a positional relationship between the view of the encoding target picture and the reference view; and
a disparity vector setting step of setting a disparity vector for the reference view using the depth map, for each of sub-areas obtained by dividing the encoding target area in accordance with the division method.

16. A video encoding method for, when encoding an encoding target picture which is one frame of a multi-view video including videos of a plurality of different views, performing predictive encoding from a reference view different from a view of the encoding target picture, for each encoding target area which is one of areas into which the encoding target picture is divided, using a depth map for an object in the multi-view video, the video encoding method comprising:
an area division step of dividing the encoding target area into a plurality of sub-areas;
a processing direction setting step of setting a processing order of the sub-areas based on a positional relationship between the view of the encoding target picture and the reference view; and
a disparity vector setting step of setting a disparity vector for the reference view using the depth map for each of the sub-areas in accordance with the order while determining an occlusion with a sub-area processed prior to each of the sub-areas.

17. A video decoding method for, when decoding a decoding target picture from encoded data of a multi-view video including videos of a plurality of different views, performing decoding while performing prediction from a reference view different from a view of the decoding target picture, for each decoding target area which is one of areas into which the decoding target picture is divided, using a depth map for an object in the multi-view video, the video decoding method comprising:
an area division setting step of determining a division method of the decoding target area based on a positional relationship between the view of the decoding target picture and the reference view; and
a disparity vector setting step of setting a disparity vector for the reference view using the depth map, for each of sub-areas obtained by dividing the decoding target area in accordance with the division method.

18. A video decoding method for, when decoding a decoding target picture from encoded data of a multi-view video including videos of a plurality of different views, performing decoding while performing prediction from a reference view different from a view of the decoding target picture, for each decoding target area which is one of areas into which the decoding target picture is divided, using a depth map for an object in the multi-view video, the video decoding method comprising:
an area division step of dividing the decoding target area into a plurality of sub-areas;
a processing direction setting step of setting a processing order of the sub-areas based on a positional relationship between the view of the decoding target picture and the reference view; and
a disparity vector setting step of setting a disparity vector for the reference view using the depth map for each of the sub-areas in accordance with the order while determining an occlusion with a sub-area processed prior to each of the sub-areas.

19. A video encoding program for causing a computer to execute the video encoding method according to claim 15.

20. A video decoding program for causing a computer to execute the video decoding method according to claim 17.

21. The video encoding apparatus according to claim 2, wherein the area division setting unit sets a direction of a division line for dividing the encoding target area to the same direction as the direction of a disparity generated between the view of the encoding target picture and the reference view.

22. The video encoding apparatus according to claim 5, wherein the disparity vector setting unit compares a disparity vector for the sub-area processed prior to each of the sub-areas with a disparity vector set for each of the sub-areas using the depth map and sets a disparity vector having a larger size as the disparity vector for the reference view.

23. The video encoding apparatus according to claim 5, further comprising a representative depth setting unit which sets a representative depth from the depth map for each of the sub-areas,
wherein the disparity vector setting unit compares the representative depth for the sub-area processed prior to each of the sub-areas with the representative depth set for each of the sub-areas, and sets the disparity vector based on the representative depth which indicates being closer to the view of the encoding target picture.

24. The video decoding apparatus according to claim 9, wherein the area division setting unit sets a direction of a division line for dividing the decoding target area to the same direction as the direction of a disparity generated between the view of the decoding target picture and the reference view.

25. The video decoding apparatus according to claim 12, wherein the disparity vector setting unit compares a disparity vector for the sub-area processed prior to each of the sub-areas with the disparity vector set using the depth map for each of the sub-areas and sets a disparity vector having a larger size as the disparity vector for the reference view.

26. The video decoding apparatus according to claim 12, further comprising a representative depth setting unit which sets a representative depth from the depth map for each of the sub-areas,
wherein the disparity vector setting unit compares the representative depth for the sub-area processed prior to each of the sub-areas with the representative depth set for each of the sub-areas, and sets the disparity vector based on the representative depth which indicates being closer to the view of the decoding target picture.

27. A video encoding program for causing a computer to execute the video encoding method according to claim 16.

28. A video decoding program for causing a computer to execute the video decoding method according to claim 18.
